(19) United States
(12) Patent Application Publication
(10) Pub. No.: US 2009/0272803 A1
(43) Pub. Date: Nov. 5, 2009

(54) SENSOR NETWORK FOR MANAGING THE LOCATION OF MATERIALS ON A CONSTRUCTION SITE

(75) Inventors: Jordan Lowell Solla, Bellevue, WA (US); Dale James Beard, Seattle, WA (US)

Correspondence Address: DAVIS & BUJOLD, P.L.L.C., 112 PLEASANT STREET, CONCORD, NH, 03301, US

(73) Assignee: INTELLIWAVE TECHNOLOGIES INC., Nisku (CA)

(21) Appl. No.: 12/435,589

(22) Filed: May 5, 2009

Related U.S. Application Data
(63) Continuation-in-part of application No. 61/050,376, filed on May 5, 2008.

(51) Int. Cl. G06Q 30/00

(52) U.S. Cl. 235/385

(57) ABSTRACT

A sensor network for managing the location of materials on a construction site includes RF sensors having unique identifiers attached to selected items. A radio frequency sensor reader network with two or more RF sensor readers sense the unique identifier of each of the radio frequency sensors and their distance from each radio frequency sensor. A processor connected to the radio frequency sensor reader network determines the location of the radio frequency sensors based on the unique identifier and distance sensed by each radio frequency sensor reader. A selection device for selects a RF sensor based on a user input, and an image capture device moves in response to the user input to display the selected radio frequency sensor on a display device.

### FIELD

Sensor networks for managing the location of materials on a construction site.

### BACKGROUND

Construction and project sites are continually evolving in terms of buildings being constructed, material areas moving, project offices expanding and so on. With these constant changes, project sites typically don't have permanent power networks, but rely on gas-powered generators or other temporary means of supplying power to areas that require it.

In today's world of construction, material handling is becoming a more automated process in terms of receiving material, finding the location of material and creating progress reports based on the flow of materials. This automated process involves attaching RF sensors to each piece of material so that all the critical material is assigned a unique ID number allowing for automated location finding. In order to read the sensor tags, a local network of RF sensor readers must be installed on the construction site. As material is delivered to the construction site and then laid down in storage areas, the sensor networks must be in range of the sensor tags to locate the position of the material. These laydown areas typically do not have easy access to power to run the optical robotics and RF sensor readers. The other issue is that as the construction site evolves, laydown areas move, requiring the sensor networks to move with the laydown areas, or expand in size as they do.

### SUMMARY

According to an aspect, there is provided a sensor network for managing the location of materials on a construction site. There are a plurality of radio frequency sensors having unique identifiers and attachments for attaching the radio frequency sensors to selected items. There is a radio frequency sensor reader network comprising two or more radio frequency sensor readers. At least two radio frequency sensor readers sensing the unique identifier of each of the radio frequency sensors and the distance from the radio frequency sensor reader to each radio frequency sensor. A processor is connected to the radio frequency sensor reader network for determining the location of at least one radio frequency sensor based on the unique identifier and distance sensed by each radio frequency sensor reader. A selection device selects a radio frequency sensor based on a user input. There is at least one image capture device that has a movable field of view. The field of view moves in response to the user input into the selection device and the corresponding location calculated by the processor to include the selected radio frequency sensor. A display device is connected to the image capture device for displaying the field of view of the image capture device.

According to an aspect, there is provided a method of managing the location of materials on a construction site. The method comprises the steps of: providing a radio frequency network comprising two or more radio frequency sensors; attaching a radio frequency tag having a unique identifier to each item on the construction site to be managed; sensing the unique identifier of at least one radio frequency tag by at least two radio frequency sensors and the distance of the at least one radio frequency tag to each of the at least two radio frequency sensors; calculating a location for each sensed radio frequency tag based on the unique identifier and distance information sensed by the radio frequency sensors; selecting a unique identifier processed by the processor; moving the field of view of an image capture device having a movable field of view to the selected radio frequency tag; and displaying the field of view of the image capture device on a display device.

According to an aspect, when project materials and equipment need to be tracked to a precise location on the project site, radio frequency (RF) sensor networks are provided in areas of the site where materials are stored. The RF sensor network determines the precise location of construction material by using triangularization algorithms. The robotic optical sensors automatically pan and zoom to the location of the materials (as determined by the RF sensors), to help material coordinators and construction managers quickly identify what the material is and where it is located. The sensor networks incorporate the use of an automated robotic camera that can pan, tilt and zoom directly into the material of interest. To power the network of RF and optical sensors, solar power is used within the design of the sensor network.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic view of a sensor network on a construction site.

### DETAILED DESCRIPTION

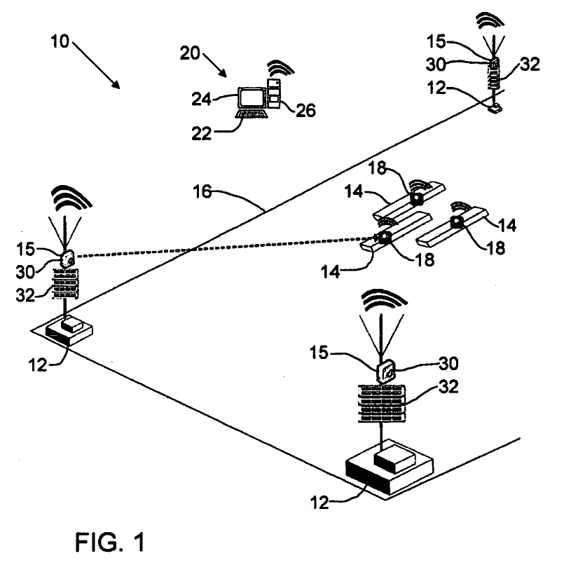

A sensor network generally identified by reference numeral 10, will now be described with reference to FIG. 1.

### Structure and Relationship of Parts:

Sensor network 10 is comprised of individual stations 12 that relay data between them by use of a wireless mesh network. Sensor network 10 is made up of two or more of the individual stations 12, and preferably three or more stations 12, depending on the algorithms used, communicating with each other to locate an item 14. In order to do this, each station 12 has a radio frequency (RF) sensor reader 15 and each item 14 to be tracked or located has a RF sensor 18 attached, which contains a unique identification number. RF sensors 18 may be attached using any practical means, such as adhesive, tie strap, pin connection, etc.

In the depicted embodiment, items 14 are metal beams in the middle of a laydown area 16 being monitored by stations 12. The laydown area 16 may be defined by one or more geofences to mark off the area and specific zones within the area for computing and sensing purposes. Each metal beam 14 has a RF sensor 18 attached, which contains a unique identification number. RF sensor readers 15 are used to detect the unique identification number of each RF sensor 18 within the geofence, or laydown area 16. RF sensor readers 15 are also used to determine the distance between each item 14 and the respective RF sensor reader 15. For example, this may be done by analyzing the received signal strength, TDOA (time difference of arrival), angle of arrival, or other techniques. Using these distances, it then becomes possible to determine the position of each metal beam 14. Clearly, if triangulation techniques are used, three or more sensor readers 15 will be required, as in the preferred embodiment.

An image capture device 30 is provided that has a movable field of view. In one embodiment, this is a digital camera mounted on a position-controllable mounting such that camera 30 can be remotely controlled to adjust its pan, tilt and zoom to view an object or area of interest. Camera 30 may display a real-time image, or it may take pictures at specified intervals. There may be a camera 30 on each station 14, or there may be one camera 30 for the entire network 12. Preferably there are multiple cameras 30 to improve the viewing options. As depicted, camera 30 and RF sensor reader 15 are housed in the same component.

The calculations used to calculate the location of each item 14 are done by a processor, such as a processor in a computer 20. Computer 20 is connected into the wireless mesh network, either by a direct connection to one of the stations 14, or by a wireless link. Computer 20 also has an input device 22, such as a keyboard, mouse, touch screen, etc., and a display device 24, such as a monitor. In one embodiment, the processor is a component in a CPU 26, which also contains a database in a memory unit for storing the information measured by RF sensor readers 15 and calculated by the processor. When input device 24 receives an input, CPU 26 directs camera 30 to find the selected item 14 within its field of view based on the coordinates calculated by the processor. This allows for visual identification of construction materials and equipment, including its accessibility, position, and asset type.

In addition to being directed toward items 14, camera 30 may also perform other functions. For example, camera 30 be manually controlled, or it may be directed toward specific areas. For example, within laydown zone 16, a user may configure additional geofences, such that camera 30 may be directed to pan and zoom to one of the zones defined by the geofences. Computer 20 may also be programmed to direct camera 30 toward a specific RF sensor 18 when a predefined geospatial event occurs, such as crossing a geofence or changing position.

It will be understood that many difference computer architectures may be used to accomplish the same goals, including integration into existing networks and systems. For example, computer 20 may be a server used for processing and routing of information on an Ethernet network.

In order to solve the issues of building a sensor network without access to permanent power, the sensor network needs alternative power systems. As depicted each station 12 includes a solar panel 32.

In addition to solving the needs for a portable system, the individual stations of the network are built so that forklifts can easily move them around or they move themselves via tracks, electric motors and wheels (not shown). As stations 12 and thus network 10 is intended to be mobile, network 10 is preferably configured to self-calibrate when base stations 12 are placed in new locations by using software to determine the current position of base stations 12 and a map of the area being monitoring. Network 12 may also be configured to communicate the position of items 14 being tracked within the radio frequency communication range of the reader network, such that the information may be read by a portable electronic device.

### Operation:

Sensor network 10 is arranged by positioning base stations 12, which are configured with cameras 30, RF sensor readers 15, solar panels 32, and are configured for wireless communication. A laydown site 16 is defined, and radio frequency sensors 18 are attached to items 14 to be tracked. In a preferred embodiment, sensor network 10 is allowed to self-configure to detect the position of each RF sensor reader 15 and possibly the environment. RF sensor readers 15 are then used to detect the unique identifier of each RF sensor 18, as well as the distance, such that the position of each item 14 can be determined. This is calculated by a processor in a computer 20, which may also be used to received commands from users via input device 22 to redirect the field of view of camera 30 to display certain items 14 on monitor 24. Preferably, the various components on base stations 14 are powered by solar panels 32.

The computer 20 or another computer, may be programmed to track the movement of items 14 as the status or location of RF sensor 18 changes. For example, the computer may be programmed to cause an alert to be activated if an item 14 is moved, or moved over a geofence. This may include causing one of the cameras 30 to track item 14 as it moves.

### Advantages:

An individual solar powered sensor station is designed to fulfill a number or requirements including:
Mobile—the units can move themselves via tracks, electric motors and wheels or can easily be moved with construction machinery.
Continuous operation year round without using line voltage
Use of sophisticated software that provides a geospatial understanding of its environment.

The individual solar powered stations 12 are also able to complete a number of functions to help automate material handling, including:
RF sensor equipment to locate the position of an RF sensor attached to construction material or equipment
Robotic optical camera to zoom or pan directly into the position of the material for visual inspection remotely
Wireless Ethernet communications to send optical and sensor data back to a central server 20 for processing and routing.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A sensor network for managing the location of materials on a construction site, comprising:
a plurality of radio frequency sensors having unique identifiers;
attachments for attaching the radio frequency sensors to selected items;
a radio frequency sensor reader network comprising two or more radio frequency sensor readers, at least two radio frequency sensor readers sensing the unique identifier of each of the radio frequency sensors and the distance from the radio frequency sensor reader to each radio frequency sensor;
a processor connected to the radio frequency sensor reader network for determining the location of at least one radio frequency sensor based on the unique identifier and distance sensed by each radio frequency sensor reader;
a selection device for selecting a radio frequency sensor based on a user input;
at least one image capture device having a movable field of view, the field of view moving in response to the user input into the selection device and the corresponding location calculated by the processor to include the selected radio frequency sensor; and
a display device connected to the image capture device for displaying the field of view of the image capture device.

2. The sensor network of claim 1, further comprising a portable power source for powering at least the radio frequency sensor reader network and the image capture device.

3. The sensor network of claim 2, wherein the portable power source is a solar power source.

4. The sensor network of claim 1, wherein the radio frequency sensor readers and the image capture device are mounted on base stations, each base station comprising a solar panel.

5. The sensor network of claim 4, wherein the base stations are mobile.

6. The sensor network of claim 1, wherein the processor contains instruction for adjusting the field of view of the image capture device by a controlling a position-adjustable mounting.

7. The sensor network of claim 1, wherein the construction site is defined by at least one geofence.

8. The sensor network of claim 1, wherein the processor contains instructions to move the field of view of the image capture device in response to a predetermined event sensed by the radio frequency sensor readers.

9. The sensor network of claim 1, wherein the processor contains instructions to calculate the distance and relative position of each radio frequency sensor reader.

10. A method of managing the location of materials on a construction site, the method comprising the steps of:
providing a radio frequency network comprising two or more radio frequency sensors;
attaching a radio frequency tag having a unique identifier to each item on the construction site to be managed;
sensing the unique identifier of at least one radio frequency tag by at least two radio frequency sensors and the distance of the at least one radio frequency tag to each of the at least two radio frequency sensors;
calculating a location for each sensed radio frequency tag based on the unique identifier and distance information sensed by the radio frequency sensors;
selecting a unique identifier processed by the processor;
moving the field of view of an image capture device having a movable field of view to the selected radio frequency tag; and
displaying the field of view of the image capture device on a display device.

11. The method of claim 10, further comprising the step of powering the sensor network with a portable power source.

12. The method of claim 11, wherein the portable power source is a solar power source.

13. The method of claim 10, further comprising the step of mounting the radio frequency sensors and a solar panel on stations, at least one station comprising the image capture device.

14. The method of claim 13, further comprising the step of moving the stations to a new location.

15. The method of claim 10, wherein the processor contains instruction for adjusting the field of view of the image capture device by a controlling a position-adjustable mounting.

16. The method of claim 10, further comprising the step of defining the construction site by at least one geofence.

17. The method of claim 10, wherein the processor contains instructions to move the field of view of the image capture device in response to a predetermined event sensed by the radio frequency sensor readers.

18. The method network of claim 10, further comprising the step of calculating the distance and relative position of each radio frequency sensor reader based on readings obtained by the radio frequency sensor readers.
